(19) United States
(12) Patent Application Publication
(10) Pub. No.: US 2013/0122140 A1
(43) Pub. Date: May 16, 2013

(54) Alkaline Mineral Booster With Antioxidants

(71) Applicant: Robert Kim, (US)

(72) Inventor: Robert Kim, (US)

(21) Appl. No.: 13/298,269

(22) Filed: Nov. 16, 2011

(51) Int. Cl. A23L 1/304; A23L 1/48; A23L 2/52; A23L 1/305

(52) U.S. Cl. 426/7; 426/648; 426/74; 426/665; 426/590

(57) ABSTRACT

A highly alkaline, ultra-low sodium antioxidant mineral additive of saturated tripotassium phosphate may be used as an additive to dosages such as concentrated drops, tablets, capsules, bottled water, beverages or other dosage forms. The alkaline antioxidant mineral additive further includes organic potassium, calcium, zinc, magnesium, selenium and 79 trace minerals from ancient sea salt. The trace minerals are taken from the low-sodium technically-processed magnesium chloride marine deposits and chelated with amino acids. The amino acids are from a non-animal source which is suitable for vegetarian and persons who are allergic to animal proteins. The alkaline antioxidant mineral additive, which is considered nutritionally nil in sodium content, can be used as a concentrated aqueous drop or dried and used as an additive for dietary supplement dosage forms including tablets, capsules, bottled water, beverages and others.

### CROSS-REFERENCE TO RELATED APPLICATION

The present application constitutes a continuation in part of the following currently co-pending commonly owned United States patent application. The subject matter of the application listed below is incorporated by reference in their entirety in the present application to the extent such subject matter is not inconsistent herewith.

U.S. patent application Ser. No. 13/024,565, filed on Feb. 10, 2011, entitled “Alkaline Booster With Antioxidants,” naming Robert Kim as the inventor.

### BACKGROUND OF THE INVENTION

1. Field of the Invention

The present invention provides the compositions of a alkaline mineral additive that is used for improving human health, and more particularly for a source of alkaline (high pH) additive for dietary supplements, concentrated drops, tablets, capsules, bottle water, beverages and related dietary supplement dosage forms.

2. Description of Related Art

For nearly a century alkaline water and electrolyte supplementation have been claimed to have certain health benefits for human body. The scientific literature for electrolyte replacement and acid-base balance has been accumulated to be voluminous, including Schwartz and Lyons, “Acid-Base and Electrolyte Balance—Normal Regulation and Clinical Disorders”, Grune & Stratton (1977); Carrol and Oh, “Water, Electrolyte and Acid-Base Metabolism”, Lippincott (1978); Kokko and Tannen, “Fluids and Electrolytes”, 2^{nd} Ed, W B Saunders Co. (1990), and others.

In addition to the piled evidence of mainstream scientific research dataf for alkaline and electrolyte supplementation, the alternative medicine community supports the supplementation of drinking water with alkaline additives. This includes Dr. Ted Baroody's “Alkalize or Die”, Holographic Health Inc, 8^{th} ed. (1991); Sang Whang's seminal book “Reverse Aging”, Jsp Publishing (1991); Dr. F. Batmanghelidj's “Your Body's Many Cries for Water”, Global Health Solutions; 2^{nd} ed. (1995); and Herman Aihara's “Acid and Alkaline” George Ohsawa Macrobiotic Foundation; 5^{th} ed. (1986).

The commercial value of alkaline water and electrolyte supplementation has been significantly increased in recent years. The water ionizer machines from various companies such as Enagic (Los Angeles, Calif.) and Chanson (Laguna Hills, Calif.) are competitively being sold on the market. These machines electrolyze the regular drinking water and separate into an acidic portion which is disposed of or for other use and an alkaline portion which is consumed for enhancing better health. These machines are bulky, require electric power source, and are relatively expensive. Further examples of the commercial value are demonstrated by the greater number of patents and commercial products of alkaline electrolyte supplement water and beverages as well as tablets, capsules, and teas.

U.S. Pat. No. 3,215,626 to Console describes a method of producing mineralized drinking water by adding potassium tri polyphosphate.

U.S. Pat. No. 5,306,511 to Whang pertains to a concentrated additive solution that is added to normal drinking water to form an alkaline drinking water. Such water is of increased oxygen content with pH said to be in the range of 9 to 12.

U.S. Pat. No. 5,849,346 to Homack discloses a concentrated hydroxide solution, which is added to the acidic beverages such as coffee, tea, wine and other alcoholic beverages. The desired pH of beverages after addition of the concentrated hydroxide solution is about 7 to 11, preferably about 10 to 10.5.

U.S. Pat. No. 6,572,902 to Abramowitz et al. discloses a process for producing alkaline drinking water and the product produced thereby. The alkaline water has a pH within the range of 9-10.

U.S. Pat. No. 7,090,878 to Mehansho et al. discloses a water composition that is fortified with minerals and has a pH between about 2.5 and 9.5.

U.S. Pat. No. 7,785,642 to Kaehne discloses mineral water compositions made of four different groups of elements. The pH is preferably adjusted to a final value of between 6.6 to 8.0 with a still water or a final value of between 2.5 to 8.0 for an aerated or carbonated water.

Having taken the growing interest from the major scientific research field, the alternative medicine sectors, and the commercial industry, and the attempts to meet these needs into consideration, it was recognized that the existing practices and technologies still leave challenges to be faced and solved.

The central theme in the alternative medicine is the consumption of alkaline vegetables and beverages. However, the so called alkaline vegetables are only pH 6 as mildly acidic so that they are not really alkaline vegetables. The chance to drink natural alkaline water is very slim, because these natural lye, high pH alkaline springs are scarce and difficult to find. No any nationwide firm is satisfying with these demands.
2. The machines that produce alkaline water are expensive for persons who live on a fixed income. Moreover, these bulky machines are burdensome to carry by those who must travel.
3. Hydroxide drops as suggested in the U.S. Pat. No. 5,306,511 to Whang, and U.S. Pat. No. 5,849,346 to Homack are irritable to skin, and eyes. Many people are afraid to use a lye based sodium and potassium hydroxide product orally in human electrolyte replacement.
4. Alkaline teas and tea bags are expensive to use regularly and are not readily available on a nationwide basis.
5. There are no nationally distributed products combining alkaline electrolytes added to regular vitamin-botanical dietary supplement.
6. Most of the examples in the aforementioned patents or commercial products still contain sodium which is not recommended by nutritionists, especially for persons with cardiovascular problems.

Unlike some of the above-mentioned patents such as the U.S. Pat. No. 7,090,878 to Mehansho et al., the U.S. Pat. No. 7,785,642 to Kaehne, the U.S. Pat. No. 6,572,902 to Abramowitz et al, and the U.S. Pat. No. 3,215,626 to Console, wherein the products are ready to drink water or beverages or powder in a pouch attached to ready to drink bottled water, the invention described and claimed in the present application relates to cencentrated mineral additive that is enriched with trace minerals from ancient sea salt and alkaline electrolytes, and produces a final pH above 9 after it is added to water or beverages. The invention in the form of an additive, rather than in a form of bulky ready to drink water or beverages, is convenient to carry so that the users can intake alkaline electrolytes and minerals any place any time. Moreover, the present invention is distinct from other patents in that the present invention produces a final pH above 9 and contains amino acids chelated with trace minerals from the ancient sea salt.

### SUMMARY OF TILE INVENTION

The object of the invention is to provide a composition of a low sodium antioxidant mineral additive for alkaline dietary supplement dosages that is mild in terms of taste and basicity, while maximizing health benefits, yet still capable of producing beverages with a final pH above 9.

Yet another objective is to create such an antioxidant mineral additive that is inexpensive, available in liquid form and dry dosage form, easy to pack and travel with and requires no power source.

Still another objective is to create such an antioxidant mineral additive that offers up to 79 additional trace minerals including lithium, beryllium, boron, carbon, nitrogen, oxygen, fluorine, sodium, magnesium, aluminum, silicon, phosphorus, sulfur, chlorine, potassium, calcium, scandium, titanium, vanadium, chromium, manganese, iron, cobalt, nickel, copper, zinc, gallium, germanium, arsenic, selenium, bromine, berkelium, rubidium, strontium, yttrium, niobium, molybdenum, technetium, ruthenium, rhodium, palladium, silver, cadmium, indium, tin, antimony, tellurium, iodine, xenon, cesium, lanthanum, cerium, praseodymium, neodymium, promethium, samarium, europium, gadolinium, terbium, dysprosium, holmium, erbium, thulium, ytterbium, lutetium, hafnium, tantalum, tungsten, rhenium, osmium, iridium, platinum, gold, mercury, bismuth, polonium, astatine, radon, barium.

A further object is to create such an antioxidant mineral additive that offers non-animal sourced amino acids or protein hydrolysate to chelate trace minerals.

A further objective is to create such an antioxidant mineral additive that does not contain any preservatives.

The foregoing and other objects, features, and advantages of the present invention are accomplished in accordance with the descriptions of the present invention. One illustrative embodiment of which comprises a highly alkaline, ultra-low sodium solution of organic potassium salts and saturated tripotassium phosphate that may be used as a mineral additive to dosages such as concentrated drops, tablets, capsules, bottle water, beverages or other dosage forms.

As previously discussed, an objective of the invention is to provide a composition of a mineral additive that is capable of producing beverages with a pH 9 or above. Among the ingredients, phosphorous is found in all cells and is involved in most biochemical reactions. It plays an important role in protein synthesis for the growth, maintenance, and repair of all tissues and cells in human body. Because high amount of sodium is harmful to the human body especially to the cardiovascular system, tripotassium phosphate is chosen as the major component in the prevent invention. Potassium is also an essential dietary mineral and electrolyte. Normal body function depends on tight regulation of potassium concentrations both inside and outside of cells. Potassium can stimulate kidney's function and stabilize heart rhythms.

The mineral additives further include calcium, potassium, magnesium, and selenium and up to 79 trace minerals from ancient sea salt, especially from the technically-processed magnesium chloride marine deposits that are low in sodium. It's known that the absorption and bioavailability of certain minerals or electrolytes by human body may be low. It's also known in the art that the bioavailability of certain minerals or electrolytes can be increased if administered in the form of chelates wherein the chelating ligands are amino acids. One solution to deliver such an additive that offers bioavailable minerals and alkaline electrolytes is disclosed in PCT publication WO 99/21437 to Better Health Lab. Inc., published on May 6, 1999, which uses amino acids derived from a non-porcine source (fish gelatin) to chelate with minerals.

Instead of using fish gelatin, the invention described and claimed in the present application utilizes amino acids from a non-animal source (papain); thus, the present invention is suitable for vegetarians or persons who are allergic to fish gelatin. Papain is an enzyme, also known as papaya proteinase I, which is present in unripe papayas. It is used in cooking as a meat tenderizer; it can break down the tough meat fibers. In the present invention, it serves as the source of amino acids; once it is heated in acidic condition (citric acid in the formula), it decomposes to free amino acids, which can chelate with trace minerals.

Another improvement over the invention published in WO 99/21437 is that the present invention does not contain any preservative. Most bacteria require an isotonic environment or a hypotonic environment for optimum growth. Very few organisms can grow at relatively high salt concentration (up to 10%). Moreover, very few organisms can grow at high alkaline (up to pH 10) environment. Considering the formula disclosed in the present invention which has high salt concentration (about 30%) and high pH (above pH 11), the organisms are less likely to grow; thus, the present invention does not need to contain any preservative.

Yet another improvement over the invention published in WO 99/21437 is that the selenium as a critical trace mineral is added to the formula disclosed in the present application. Human require selenium for the function of a number of selenium-dependent enzymes, also known as selenoproteins. Selenium is an antioxidant that protects cell membranes and intra-cellular structural membranes from lipid peroxidation. Selenium deficiency has been associated with muscular weakness, impaired function of the immune system and others.

The present invention which is considered nutritionally nil in sodium content, can be used as a concentrated aqueous drop, or dried and used as an additive for dietary supplement dosage forms including tablets, capsules, bottled water, beverages and others.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### DESCRIPTION OF THE PREFERRED EMBODIMENT

The purpose of the invention is to provide the composition of an alkaline antioxidant mineral additive which has low sodium and multiple essential minerals to a dietary supplement dosage form not only to increase its pH to about 8-10, preferably 9, but also to rejuvenate human body from the minerals replenished. The beverage or product thus created or modified are not intended to treat or cure any disease. They do, however, neutralize acids and they do enable the user or patient to achieve an alkaline lifestyle plus receiving benefits from electrolytes and minerals.

Initially the deionized water is filled into a previously sanitized stainless steel steam jacketed vessel equipped with a propeller mixer. Alternatively, the deionized water may be heated to 80-90 degrees Celsius via a heat exchange unit.

Citric acid and a trace mineral (special marine sea salt) concentrate is introduced along with papain enzyme which has a high proteolytic activity. As this mixture is slowly cooled, the hot papain enzyme is cleaved in the hot acidic environment and decomposed to free amino acids, which can chelate the trace minerals.

Slow mixing with slow cooling is continued until the mixture reaches about 50 degrees Celsius.

At this point an electrolyte mixture with saturated tripotassium phosphate is added and then organic potassium salts including potassium bicarbonate, potassium citrate, and potassium lactate 60% are added, a preweighed amounts of magnesium chloride, zinc lactate, calcium chloride and selenium are also added.

The slurry resulting therefrom is somewhat opaque and may require setting before final filtration. The product is cooled without mixing for 24 hours for complete coagulation of the non-soluble portions.

For the next operation, the product is decanted, running through a fine filter of preferably 10-175 μm cartridge and packaged, or processed further.

The product is now a clear liquid and can be dispensed as a clear drop in a small dropper assembly, operating closure, droplet cap or preferably “drop-trainer”. When processed further it can be dried on a drum drier and added to the formulation of conventional vitamin-mineral-botanical dosage forms including tablets, capsules, bottled water and beverages.

The invention is further characterized by the tripotassium phosphate being in the 10-50% range of the total weight of the product, the organic potassium being in the 0.1-3% range, the minerals being in the 1-40 ppm range, the amino acids being in the 2-500 ppm range, the citric acids being in the 0.01-0.25% range and the papain enzymes being in the 2-500 ppm.

The above procedure is the most preferred embodiment of the invention. Moderate ranges occur around these percentages and procedures and are included in this patent.

The ranges above are the embodiment of the patent. The preferred range are about: 15-35% of tripotassium phosphate, 0.03-3% organic potassium salts, 3-25 ppm of trace minerals, 0.03-18% citric acid and 5-250 ppm high proteolytic papain enzyme. The preferred filtering range would be using a 20-125 micron cartridge.

The most preferred embodiment of the patent would be about 30% of the tripotassium phosphate, 0.05-2% organic potassium salts, 5-15 ppm trace minerals, 0.05-10% citric acid, 20-40 ppm high proteolytic enzyme. The most preferred filtration cartridge is 10-20 micron.

The most preferred ingredient ranges should be a balance of many factors such as efficacy, taste, economical aspects, and ease of production.

In all cases the dosage form should be expected to increase the alkalinity in the human system. For example, when two drops of this low sodium additive drop (or one unit of the tablet, capsule, tea bag, etc.) is used in or with a single 8-10 ounce beverage cup, the resultant pH will be approximately 8-10, preferably 9.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

### EXAMPLE

One suitable example of the invention in liquid form for human consumption, which is by no means exclusive, is as follows:

| Ingredient | % by weight |
|---|---|
| High proteolytic papain enzyme | 0.001 |
| Citric acid | 0.20 |
| Technically processed magnesium chloride | 0.10 |
| (marine source) | |
| Tripotassium phosphate | 30 |
| Magnesium chloride | 0.03 |
| Selenium (Selenite) | 0.03 |
| Potassium bicarbonate | 6.00 |
| Zinc lactate | 0.05 |
| Potassium citrate | 0.10 |
| Calcium chloride | 0.05 |
| Potassium lactate 60% | 2.00 |
| Purified deionized water | qs |

### Example 2

Another suitable example of the invention in liquid form for human consumption, which is by no means exclusive, is as follows:

| Ingredient | % by weight |
|---|---|
| High proteolytic papain enzyme | 0.001 |
| Citric acid | 0.24 |
| Technically-processed magnesium | 0.10 |
| chloride (marine source) | |
| Tripotassium phosphate | 32 |
| Magnesium chloride | 0.03 |
| Selenium (Selenite) | 0.03 |
| Potassium bicarbonate | 5.00 |
| Zinc lactate | 0.04 |
| Potassium citrate | 0.10 |
| Calcium chloride | 0.05 |
| Potassium lactate 60% | 2.00 |
| Purified deionized water | qs |

Although this invention has been described in terms of a preferred embodiment, various changes and modifications can be made without departing from the intention and scope of the invention.

Although this invention has been described in terms of a preferred embodiment, various changes and modifications can be made without departing from the spirit and scope of the invention.

What is claimed is:

1. A low sodium alkaline antioxidant mineral additive for alkaline: dietary supplement dosages comprises saturated tripotassium phosphate, with the concentration of tripotassium phosphate being from about 10-50 percent by weight, amino acids from papain, wherein said alkaline antioxidant mineral water is stable in the absence of preservatives.

2. The alkaline antioxidant mineral additive of claim 1, wherein the tripotassium phosphate being preferably about 30% by weight.

3. The alkaline antioxidant mineral additive of claim 1 further comprises trace amount of calcium.

4. The alkaline antioxidant mineral additive of claim 1 further comprises trace amount of magnesium.

5. The alkaline antioxidant mineral additive of claim 1 further comprises trace amount of zinc.

6. The alkaline antioxidant mineral additive of claim further comprises trace amount of selenium.

7. The alkaline antioxidant mineral additive of claim 1 further includes 79 trace minerals from sea.

8. The alkaline antioxidant mineral additive of claim 7, wherein the trace minerals are selected from low sodium technical magnesium chloride marine deposits.

9. The alkaline antioxidant mineral additive of claim 8 further comprises amino acids from non-animal sources.

10. The alkaline antioxidant mineral additive of claim 9, wherein the trace minerals are chelated with free amino acids.
A low sodium alkaline antioxidant mineral additive for alkaline dietary supplement dosages comprises tripotassium phosphate, with the concentration of tripotassium phosphate being from about 10-50 percent by weight, organic potassium salts, trace minerals, citric acid, amino acids, and trace amount of magnesium, zinc, selenium, calcium; the trace minerals are chelated with amino acids.

12. The alkaline antioxidant mineral additive of claim 11, wherein the amino acids are derived from non-animal peptides or proteins.

13. The alkaline antioxidant mineral additive of claim 11, wherein the trace minerals are selected from low sodium technical magnesium chloride marine deposits.

14. The alkaline antioxidant mineral additive of claim 11, wherein the preferred range are about 15-35% tripotassium phosphate, 0.03-3% organic potassium salts, 3-35 ppm trace minerals, 0.03-18% citric acid, 5-250 ppm of amino acids derived from 5-250 ppm high proteolytic enzyme, and trace amount of magnesium, zinc, selenium, calcium; all the units are weight by weight.

15. The alkaline antioxidant mineral additive of claim 11, wherein the preferred range are about 30% of tripotassium phosphate, 0.05-2% organic potassium salts, 5-15 ppm trace minerals, 0.05-10% citric acid, 20-40 ppm of amino acids derived from 20-40 ppm high proteolytic enzyme, and trace amount of magnesium, zinc, selenium, calcium; all the units are weight by weight.

16. A method for producing the low sodium alkaline mineral additive for alkaline dietary supplement dosages comprising tripotassium phosphate, with the concentration of tripotassium phosphate being from about 10-50 percent by weight.

17. The alkaline antioxidant mineral additive of claim 1 may be packaged in a small dropper assembly, operating closure, droplet cap or drop-trainer.

18. The alkaline antioxidant mineral additive of claim 1 may be further dried and added to the formulation of conventional vitamin-mineral-botanical dosage forms including tablets, capsules, bottled water, beverages and the like.

19. A method of preparing alkaline antioxidant mineral additive of claim 1, comprising the steps of:
(i) fill deionized water into a previously sanitized stainless steel steam jacketed vessel equipped with a propeller mixer;
(ii) heat said deionized water to 70-90 degrees Celsius via a heat exchange unit;
(iii) add and mix 0/03-20% citric acid and 3-38 PPM trace minerals; add and mix a high proteolytic activity 0.002% papain enzyme;
(v) cool down the mixture from step (iv) to about 50 degrees Celsius;
add saturated 1540% tripotassium phosphate and 0.03-2% organic potassium salts selected from the group consisting of 5-10% potassium bicarbonate, 0.1-0.4% potassium citrate, and 2.00-4.00% potassium lactate;
add pre-weighed amounts of 0.03%-0.05% magnesium chloride, 0.05-0.08% zinc lactate, 0.05-0.09% calcium chloride and 0.03-0.08% selenium to form a slurry;
filtrate the mixture from step (vii) to obtain an aqueous solution;
(ix) cool down said aqueous solution from step (viii) without mixing for up to 24 hours; and
(x) decant and run through a 10-200 μm cartridge to obtain said preservative free and stable alkaline antioxidant mineral additive.
